(19) United States
(12) Patent Application Publication
(10) Pub. No.: US 2018/0326231 A1
(43) Pub. Date: Nov. 15, 2018

(54) CRYSTALLINE SALTS OF ORGANOMETALLIC COMPLEXES FOR OXYGEN SUPPLY IN AIRCRAFTS

(71) Applicants: Günter Boomgaarden, Scharbeutz (DE); Wolfgang Rittner, Ahrensbök (DE); Rüdiger Meckes, Berkenthin (DE)

(72) Inventors: Günter Boomgaarden, Scharbeutz (DE); Wolfgang Rittner, Ahrensbök (DE); Rüdiger Meckes, Berkenthin (DE)

(21) Appl. No.: 15/533,931

(22) PCT Filed: Dec. 10, 2015
(86) PCT No.: PCT/IB2015/002447

§ 371 Date: Jun. 7, 2017

(51) Int. Cl. A62B 7/08; A62B 7/14; A62B 21/00; B01J 20/22

(52) U.S. Cl. CPC A62B 7/08; A62B 7/14; B64D 2231/025; B01J 20/226; A62B 21/00

(57) ABSTRACT

A method for providing oxygen to crew member or passenger of an aircraft comprising:
providing a chemical absorption substance selected from crystalline salts of organometallic complexes, wherein said chemical absorption substance stores oxygen in a chemisorption process,
arranging the chemical absorption substance in a container connected to an oxygen mask via an oxygen line,
releasing oxygen out of said chemical absorption substance in case of an emergency situation in a cabin or cockpit, onboard of an aircraft requiring oxygen supply to said crew member or passenger, and
directing said oxygen in a gaseous state via said oxygen line to said oxygen mask.

### FIELD OF THE DISCLOSURE

The invention relates to emergency oxygen systems on board of an aircraft and methods for providing oxygen to crewmembers or passengers on board of an aircraft in an emergency situation. The invention further relates to oxygen supply systems used for prebreathing application of crew members in the cockpit of an aircraft as prescribed by air traffic regulations and to portable oxygen supply devices such as for medical or therapeutic use onboard of an aircraft. According to the description and the claims hereafter, any of these methods and devices shall be understood as an emergency oxygen supply method or an emergency oxygen system, respectively.

### BACKGROUND OF THE DISCLOSURE

Generally, it is known to provide oxygen out of an oxygen source to persons on board of an aircraft in an emergency situation like a decompression event, smoke or fire on board of an aircraft. The oxygen source may be an On-Board-Oxygen-Generating-System (OBOGS), a pressurized oxygen tank or a Chemical Oxygen Generator (COG). Chemical Oxygen generators are known to be composed of a housing, wherein a substance is stored that will release oxygen in a chemical reaction.

COG devices known in the prior art produce oxygen in an exothermic and thus without energy input generally irreversible process and have some drawbacks with regard to efficiency, safety, the start-up phase and the duration of the oxygen supply.

The process is known to start slowly such that in a decompression event at high altitude the delivery rate may be insufficient to safely prevent affection of the vital functions of the passenger. Further, the exothermic reaction creates an increase in temperature thus raising safety issues with regard to potential fire or smoke production. Still further, the relation of capacity versus weight of such COG systems is an ongoing process of optimisation with regard to fuel efficiency of modern aircraft.

### SUMMARY OF THE DISCLOSURE

According to the invention, the method for providing oxygen to crew member or passenger of an aircraft, in particular an emergency situation, comprises:
providing a chemical absorption substance selected from crystalline salts of organometallic complexes, wherein said chemical absorption substance stores oxygen in a chemisorption process,
arranging said chemical absorption substance in a container, said container having an outlet opening, wherein said outlet opening is connected to an oxygen mask via an oxygen line for directing an oxygen fluid flow out of said container to said oxygen mask, wherein said oxygen mask is adapted to cover mouth and/or nose of said crew member or passenger, respectively,
releasing oxygen out of said chemical absorption substance in case of an emergency situation in a cabin or cockpit, onboard of an aircraft requiring oxygen supply to said crew member or passenger, and
directing said oxygen in a gaseous state via said oxygen line to said oxygen mask.

The method improves capacity to weight relation and reduces problems of delayed generation of oxygen in start up and safety issues related to temperature of the system components. According to the invention a specific chemical absorption substance is used to store oxygen and to release such oxygen for supplying it to the passenger or crew member.

Specific further embodiments are shown in dependent claims.

The invention also deals with a use of a chemical absorption substance selected from crystalline salts of organometallic complexes for providing oxygen to a crew member or a passenger.

The invention further deals with an aircraft emergency oxygen device for providing oxygen to crew member or passenger, comprising a chemical absorption substance selected from crystalline salts of organometallic complexes, a container, an oxygen line and an oxygen mask, wherein:
said chemical absorption substance is adapted to store oxygen in a chemisorption process,
said chemical absorption substance is positioned inside the container, said container having an outlet opening, wherein said outlet opening is connected to the oxygen mask via the oxygen for directing an oxygen fluid flow out of said container to said oxygen mask, wherein said oxygen mask is adapted to cover mouth and/or nose of said crew member or passenger, respectively,
said chemical absorption substance is adapted to release oxygen in case of an emergency situation onboard of an aircraft requiring oxygen supply to said crew member or passenger.

### BRIEF DESCRIPTION OF THE DRAWINGS

Other features and advantages of the present invention will appear in the following detailed description, with reference to the appended drawings in which:

FIG. 1 schematically represent an embodiment aircraft emergency device in accordance with the invention,

FIG. 2 represents an alternative embodiment in accordance with the invention.

### DETAILED DESCRIPTION OF THE DISCLOSURE

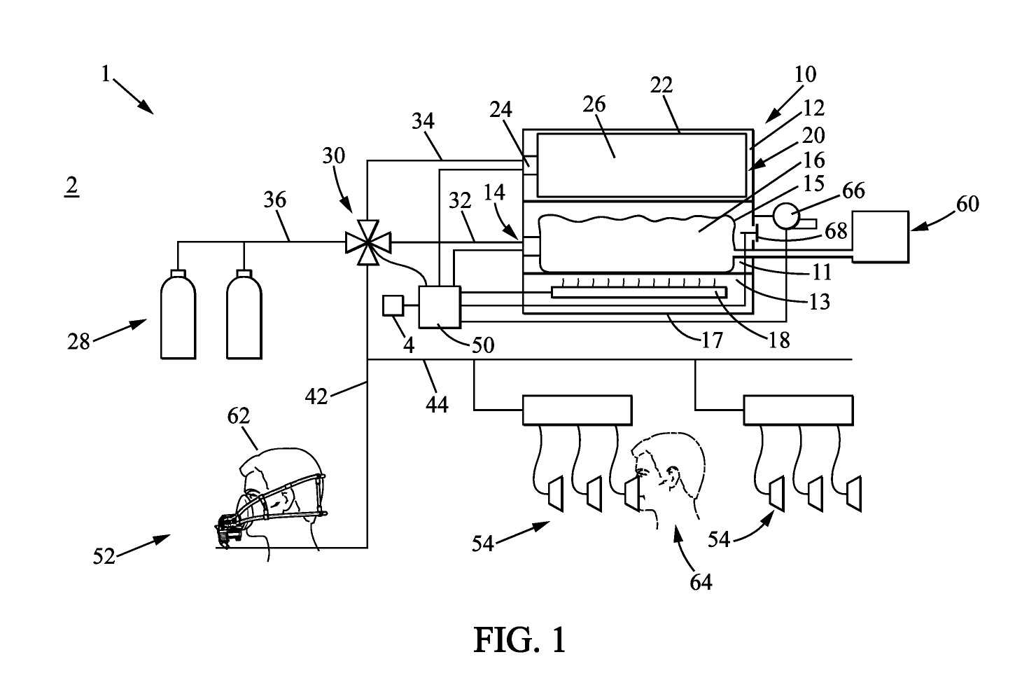

FIG. 1 represents an emergency oxygen device 1 in a cabin 2 of an aircraft.

The emergency oxygen device 1 comprises a chemical absorption substance 16 disposed in a container 10. The container 10 has an outlet opening 14 connected to first respiratory masks 52 for crewmembers 62 and several groups of second respiratory masks 54 for passengers 64.

More accurately, in the embodiment shown in FIG. 1, the container 10 comprises a casing 17 having a first section 11, a second section 12 and a third section 13. The container 10 further comprises a flexible housing 15 forming a sealed bag and containing the chemical absorption substance 16. The flexible housing 15 is placed in the first section 11 of the container 10.

In the embodiment shown in FIG. 1, the emergency oxygen device 1 further comprises a chemical oxygen generator 20 placed in the second section 12. The chemical oxygen generator 20 mainly comprises a rigid housing 22 containing a chemical substance 26 and a starter unit 24.

In the embodiment shown in FIG. 1, the emergency oxygen device 1 further comprises a conditioning system 18 placed in the third section 13 and which enables to modify the temperature of the chemical absorption substance 16, the first section 11, the second section 12 and the third section 13 being in thermal communication with each other.

In the embodiment shown in FIG. 1, the emergency oxygen device 1 further comprises an optional battery of gas bottles 28 storing pure oxygen at high pressure (conventionally more than 100 bars).

The emergency oxygen device 1 further comprises a distribution valve 30. The distribution valve 30 is respectively supplied in oxygen from the chemical absorption substance 16 through a first conduit 32, from the chemical oxygen generator 20 through a second conduit 34 and from the battery of gas bottles 28 through a third conduit 36 which define three oxygen sources.

The crewmember masks 52 and the passenger masks 54 are supplied in oxygen from the distribution valve 30 through a first distribution line 42 and a second distribution line 44. The distribution valve 30 is controlled by the control unit to select the source of oxygen supplying the first distribution line 42 and the second distribution line 44. The first conduit 32, the first distribution line 42 and the second distribution line 44 define a oxygen line for directing an oxygen fluid flow from the container 10 to the crewmember masks 52 and the passenger masks 54. The crewmember masks 52 and the passenger masks 54 are preferably adapted to cover mouth and/or nose respectively of the crewmembers 62 and the passengers.

The chemical substance 26 in the rigid housing is for instance NaClO₃ possibly with accelerators for the chemical reaction, like a substance of Fe₂O₃ or Na₂O or the like. Further additives for stabilizing and thermally driving and/or stabilizing the chemical reaction can also be provided to the chemical oxygen generator 20. The starter unit 24 advantageously comprises a piezoelectric ignition element. Once heat is provided to the chemical substance 26 thanks to the starter unit 24, oxygen is generated in a reaction to give O₂ and also heat as the reaction is exothermic.

The chemical absorption substance 16 used according to the present invention is selected from crystalline salts of organometallic complexes which reversibly, selectively and stoichiometrically chemisorb dioxygen. Preferably, chemisorption of dioxygen follows a process involving the two electron oxidation of metallic sites within the complexes with concurrent reduction of two equivalents of absorbed O₂ to form μ-η¹,η²-peroxide ligands thereby optionally substituting other ligands of said absorption substance.

Preferably, the chemical absorption substance 16 used according to the present invention comprises an organo-cobalt compound or an organo-chromium compound.

In a preferred aspect, the chemical absorption substance 16 is selected from bimetallic [(bpbp)Co₂(O₂)(O₂CR)](A)₂ and tetrametallic [{(bpbp)Co₂(O₂)}₂(bdcR₄)](A)₄ with R being selected from the group consisting of methyl, phenyl, chloromethyl, dichloromethyl and trichloromethyl, and A being selected from the group consisting of perchlorate, hexafluorophosphate, tetrafluoroborate, trifluorornethylsulfate and nitrate. In the above chemical formulae, (bpbp) means the 2,6-bis(N,N-bis(2-pyridylmethyl)-aminomethyl)-4-tert-butylphenolato ligand, and (bdc) means the 1,4-benzenedicarboxylato ligand. The synthesis of the above bimetallic and tetrametallic compounds is described in Chem. Sci., 2014, 5, 4017, which disclosure is fully incorporated by reference. On the stoichiometric uptake of O₂, the crystals of the above organo-cobalt compounds undergo reversible single-crystal-to-single-crystal (SC-to-SC) transformations. These SC-to-SC processes involve the concerted fast migration of neutral dioxygen through the crystal lattice. Likewise, dioxygen is released out of the absorption substance in a desorption process including single-crystal-to-single-crystal (SC-to-SC) transformations.

In another preferred aspect, the absorption substance is Cr₃(1,3,5-benzenetricarboxylate)₂, which may be prepared from reaction of Cr(CO)₆ with trimesic acid according to J. Am. Chem. Soc. 2010, 132, 7856, which disclosure is fully incorporated by reference. Cr₃(1,3,5-benzenetricarboxylate)₂ is capable of reversible, selective binding of dioxygen at a high loading capacity within its metal-organic framework (MOF) featuring open Cr(II) coordination sites. Cr₃(1,3,5-benzenetricarboxylate)₂ represents the first Cr(II) based metal-organic framework (MOF), which displays both a high dioxygen loading capacity and strong selectivity for binding dioxygen over dinitrogen at 298K. On the stoichiometric uptake of O₂, there is a partial charge transfer from the Cr(II) center to the bound dioxygen molecule, which may result in a complete charge transfer to give a Cr(III)-superoxide adduct.

The chemical absorption substance 16 is advantageously loaded and unloaded cyclically with oxygen. Oxygen is stored in the chemical absorption substance 16 and released out of said chemical absorption substance 16 in a chemical reaction or desorption process in order to supply the crewmembers 62 and the passengers 64. Thereafter, oxygen is stores in said chemical absorption substance 16 again in an adsorption or chemisorptions process again for a further use of the oxygen thereafter. This cycle may be repeated several times thus helping to optimize the use of resources and to reduce waste.

To this aim, the chemical absorption substance 16 is advantageously used in an On-Board-Oxygen-System (OBOGS) 60 as an adsorption substance, e.g. instead of zeolite commonly used as an adsorbent material in OBOGS. According to this embodiment the adsorption substance is used in a cyclic pressure swing adsorption process to adsorb oxygen in a pressurized state and to release oxygen in a depressurized or low-pressure state.

According to another aspect, the chemical adsorption substance 16 is exposed to a temperature cycle including heating-up phases and cooling-down phases cyclically following each other. In such a temperature cycle the adsorption substance may cyclically be loaded with oxygen and release oxygen.

The temperature cycle is preferably controlled by the control unit 50 thanks to the conditioning system 18. In an alternative embodiment, the conditioning system 18 could be replaced by a heater. In such a case, the control unit 50 would control the desorption process. In an other alternative embodiment, the conditioning system 18 could be removed.

Otherwise, the reaction in the Chemical Oxygen Generator 20 provides heat in the container 10 which can be used in the desorption process of the chemical adsorption substance 16 and controlled by the control unit 50.

According to a further aspect of the invention, the chemical absorption substance 16 is stored in a pressurized state. As the housing 15 is flexible the pressure applied to the chemical absorption substance 16 is equal to the pressure in the first section 11 of the container 10. So, the first section 11 of the container 10 is pressurized in order to increase the capability of storing oxygen of the chemical absorption substance 16. The desorption process is enhanced by applying a low oxygen pressure to the chemical absorption substance 16, in other words by decreasing the pressure applied to the chemical absorption substance 16. To this aim, the control unit 50 controls an exhausting valve 68 in order to enable the pressurized air in the first section 11 to leak into the cabin 2 or to prevent it. The control unit 50 also controls a compressor 66 in order to increase the pressure in the first section 11 of the container 10 when the exhausting valve 68 is closed.

According to such aspect, exposure of the chemical adsorption substance 16 to ambient pressure changes in the cabin 2 like those occurring on board of an aircraft in regular use is prevented and thus any desorption and adsorption or chemisorptions process resulting from such pressure changes is inhibited.

In an alternative embodiment, the fluid communication between the first section 11 of the container 10 and the ambient air of the cabin 2 can be continuously maintained. So, in case of depressurization in the cabin 2, the pressure applied to the chemical absorption substance 16 is accordingly reduced which contributes to the desorption process.

The control unit 50 further comprises at least one sensor 4 adapted to detect an emergency situation on board of said aircraft, e.g. a decompression situation or a smoke or fire situation.

In a case of detection of an emergency situation, the control unit 50 controls the supplying of oxygen to crewmember masks 62 and to the passenger masks 64. To this aim, the control unit 50 controls the desorption process from the chemical absorption substance 16 and optionally the exothermic reaction producing oxygen thanks to the chemical oxygen generator 20. As explained above, the control unit 50 controls the pressure and/or the temperature applied to the chemical absorption substance 16 in order to control the desorption process. The control unit 50 also control the distribution valve 30 to select the source of oxygen supplying the crewmember masks 62 and/or the passenger masks 64 with oxygen.

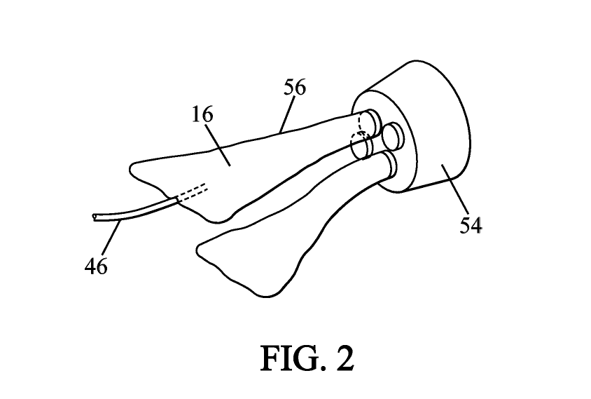

FIG. 2 illustrates the chemical adsorption substance 16 included in an economizer bag 56 attached to a passenger mask 54. Such bags 56 are usually provided to temporarily store oxygen in order to compensate the continuous flow of oxygen from the oxygen sources and the discontinuous breathing of passenger. Such bags are usually placed in a thin line 46 downstream the second distribution line 44 and upstream the passenger mask 54. The economiser bag 56 is partially filled with the chemical adsorption substance 16 to provide for a rapid startup of the supply and to provide auxiliary storage of oxygen, thus allowing decreasing the size and the flow from the oxygen sources.

According to the invention, the chemical adsorption substance 16 can be included in an economizer bag 56 per respiratory mask as shown in FIG. 2 and/or in a container 10 distant from the respiratory masks and supplying a plurality of respiratory mask 52, 54 with oxygen as shown in FIG. 1.

1. A method for providing oxygen to crew member or passenger of an aircraft, in particular an emergency situation, comprising:
providing a chemical absorption substance selected from crystalline salts of organometallic complexes, wherein said chemical absorption substance stores oxygen in a chemisorption process,
arranging said chemical absorption substance in a container, said container having an outlet opening, wherein said outlet opening is connected to an oxygen mask via an oxygen line for directing an oxygen fluid flow out of said container to said oxygen mask, wherein said oxygen mask is adapted to cover mouth and/or nose of said crew member or passenger, respectively,
releasing oxygen out of said chemical absorption substance in case of an emergency situation in a cabin or cockpit, onboard of an aircraft requiring oxygen supply to said crew member or passenger, and
directing said oxygen in a gaseous state via said oxygen line to said oxygen mask.

2. The method according to claim 1, wherein said container is adapted to have an internal pressure condition corresponding to the cabin or cockpit pressure inside said aircraft, wherein said oxygen is released out of said chemical absorption substance by applying a low oxygen pressure to said chemical absorption substance, in particular by reducing the pressure applied to said chemical absorption substance.

3. The method according to claim 2, wherein said container comprises a flexible housing such that a decompression condition on board of said aircraft causes an expansion of said flexible housing and thus a low pressure condition inside said flexible housing, wherein said oxygen is released out of said chemical absorption substance by applying a low oxygen pressure to said chemical absorption substance.

4. The method according to claim 2, wherein the oxygen is released out of said chemical absorption substance by a pressure reduction inside said flexible housing applied by the crew member or the passenger, respectively, when inhaling through said oxygen mask.

5. The method according to claim 1, wherein a heating element is provided in said container for heating said chemical absorption substance, said heating element being connected to a control unit, wherein said control unit is adapted to detect an emergency situation on board of said aircraft, e.g. a decompression situation or a smoke or fire situation, and to activate said heating element upon detection of such an emergency situation.

6. The method according to claim 5, wherein said heating element comprises a chemical substance which can be initiated by said control unit for starting an exothermic chemical reaction.

7. The method according to claim 5, wherein said heating element comprises a chemical oxygen generator comprising a chemical substance releasing oxygen in an exothermic chemical reaction.

8. The method according to claim 7, wherein said chemical substance is selected from:
inorganic superoxides,
chlorates,
perchlorates, or
ozonides.

9. The method according to claim 7, wherein said chemical substance is selected from:
Sodium chlorate,
Barium peroxide,
Potassium perchlorate, or
a mixture thereof.

10. The method according to claim 5, wherein said chemical reaction in said chemical substance is triggered by a starter unit, in particular a piezoelectric ignition element.

11. The method according to of claim 1, wherein said chemical absorption substance comprises an organo-cobalt compound or an organo-chromium compound.

12. The method according to claim 1, wherein said oxygen is stored in said chemical absorption substance in a process involving a two electron oxidation of bimetallic cobalt sites with concurrent reduction of two equivalents of absorbed O₂ to form μ-η¹,η²-peroxide ligands thereby substituting other ligands of said absorption substance.

13. The method according to claim 1, wherein oxygen is released out of said chemical absorption substance in a desorption process including a single-crystal-to-single-crystal transformation.

14. The method according to claim 1, wherein said chemical absorption substance is selected from Rbpbp)Co₂(O₂)(O₂CR)](A)₂ and [{(bpbp)Co₂(O₂)}₂(bdcR₄)](A)₄ with R being selected from the group consisting of methyl, phenyl, chloromethyl, dichloromethyl and trichloromethyl, and A being selected from the group consisting of perchlorate, hexafluorophosphate, tetrafluoroborate, trifluoromethylsulfate and nitrate.

15. The method according to claim 1, wherein said chemical absorption substance is Cr₃(1,3,5-benzenetricarboxylate)₂.

16. Use of a chemical absorption substance selected from crystalline salts of organometallic complexes for providing oxygen to a crew member or a passenger in an aircraft in an emergency situation wherein
said chemical absorption substance is adapted to store oxygen in a chemisorption process,
said chemical absorption substance is positioned inside a container, said container having an outlet opening, wherein said outlet opening is connected to an oxygen mask via an oxygen line for directing an oxygen fluid flow out of said container to said oxygen mask, wherein said oxygen mask is adapted to cover mouth and/or nose of said crew member or passenger, respectively,
said chemical absorption substance is adapted to release oxygen in case of an emergency situation onboard of an aircraft requiring oxygen supply to said crew member or passenger.

17. Use of a chemical absorption substance according to claim 16 wherein oxygen is released out of said chemical absorption substance in a desorption process preferably including a single-crystal-to-single-crystal transformation.

18. An aircraft emergency oxygen device for providing oxygen to crew member or passenger, comprising a chemical absorption substance selected from crystalline salts of organometallic complexes, a container, an oxygen line and an oxygen mask, wherein
said chemical absorption substance is adapted to store oxygen in a chemisorption process,
said chemical absorption substance is positioned inside the container, said container having an outlet opening, wherein said outlet opening is connected to the oxygen mask via the oxygen line for directing an oxygen fluid flow out of said container to said oxygen mask, wherein said oxygen mask is adapted to cover mouth and/or nose of said crew member or passenger, respectively,
said chemical absorption substance is adapted to release oxygen in case of an emergency situation onboard of an aircraft requiring oxygen supply to said crew member or passenger.

19. Aircraft emergency oxygen device according to claim 18 wherein oxygen is adapted to be released out of said chemical absorption substance in a desorption process preferably including a single-crystal-to-single-crystal transformation.

20. Aircraft emergency oxygen device according to claim 18 wherein said container comprises a flexible housing containing the chemical absorption substance.

21. Aircraft emergency oxygen device according to claim 20 wherein the flexible housing is supported by a respiratory mask and adapted to enable a user to inhale the gas within the flexible housing.

22. Aircraft emergency oxygen device according to claim 18 wherein the aircraft emergency oxygen device further comprises a control unit and a heating device connected to the control unit and adapted to heat the chemical absorption substance.

23. Aircraft emergency oxygen device according to claim 22 wherein the container comprises a casing, the heating device and the chemical absorption substance being within said casing.

24. Aircraft emergency oxygen device according to claim 22 wherein the heating device comprises a chemical substance which can be initiated by said control unit for starting an exothermic chemical reaction.

25. Aircraft emergency oxygen device according to claim 24 wherein the aircraft emergency oxygen device further comprises a starter unit, in particular a piezoelectric ignition element, adapted to trigger chemical reaction in said chemical substance.

26. Aircraft emergency oxygen device according to 22 wherein said heating element comprises a chemical oxygen generator.

27. Aircraft emergency oxygen device according to claim 22 wherein the aircraft emergency oxygen device comprises a cooling device connected to the control unit and adapted to cool the chemical absorption substance.

28. Aircraft emergency oxygen device according to claim 21 wherein the control unit comprises a sensor to detect an emergency situation on board of said aircraft, e.g. a decompression situation or a smoke or fire situation.

29. Aircraft emergency oxygen device according to claim 18 further comprising an On-Board-Oxygen-System adapted to supply oxygen to the chemical absorption substance.

30. Aircraft emergency oxygen device according to claim 18 wherein the container is within ambient air and comprises a section and an exhausting valve controlled by a control unit, the chemical absorption substance is within said section and the exhausting valve selectively isolates said section from the ambient air or allows fluid communication between said section and the ambient air.

31. Aircraft emergency oxygen device according to claim 30 wherein the aircraft emergency oxygen device further comprises a source of pressurized gas, in order to pressurize said section with respect to ambient air.
